(19) United States
(12) Patent Application Publication
(10) Pub. No.: US 2016/0048794 A1
(43) Pub. Date: Feb. 18, 2016

(54) PROJECT AND TASK STATUS INDICATOR GENERATOR USING BASELINE METRICS

(71) Applicant: Hartford Fire Insurance Company, Hartford, CT (US)

(72) Inventor: Robert Michael Taylor, New Fairfield, CT (US)

(21) Appl. No.: 14/457,434

(22) Filed: Aug. 12, 2014

(51) Int. Cl. G06Q 10/06

(52) U.S. Cl. CPC G06Q 10/063114

(57) ABSTRACT

Embodiments include a system for updating status indicators for an insurance company project using a baseline metric, including: a processor that accesses the current status entry for the task and updates a status indicator assigned to the task using a task completion metric, a current status entry for the task, a planned start task baseline date and/or a planned finish task baseline date. Other aspects are described and claimed.

### BACKGROUND

In project management, organizing of tasks is necessary. To this end, project management systems have been devised to assist in mapping out various projects, organizing the tasks that are to be completed in the project life cycle, and tracking the progress of the project. By way of example, an insurance company may employ a project management system in order to facilitate project creation, and once implemented, track project status and results.

Reporting and other functions are commonly available in such conventional project management systems. For example, Microsoft PROJECT includes software that provides project management capabilities, including report generation capabilities. Such reports may be created, e.g., in chart or table format, to analyze the project and share results thereof.

In current project management systems a drawback is the inability to track task progress and assign accountability in a refined way. For example, while a report may be generated using existing project management systems, the report is typically limited to generic metrics that tend to be applied at the project level and in summary form. It is thus not possible to obtain refined tracking using automatically generated task statuses. Another problem with conventional systems is that they do not provide for task status indicators that are determined using baseline settings for the project, i.e., providing refined tracking of task progress and completion for the reviewer.

### BRIEF SUMMARY

In summary, an embodiment provides a system for updating status indicators for an insurance company project using a baseline metric. In an embodiment, a database stores data related to an insurance project. An input element accepts a current status entry for a task of the insurance project. The system includes a processor and a memory, where the processor executes instructions to access the data stored in the database to extract a task completion metric, a planned task start baseline date, and a planned task finish baseline date. Additionally, the current status entry for the task is accessed. Using this data, the system updates, based on the current status entry for the task, a status indicator assigned to the task. Moreover, the system generates, in a visual display, a description summarizing the updated status indicator.

The updated status indicator assigned to the task may be selected from the group consisting of: a complete indicator, a future indicator, an on indicator, an in jeopardy indicator, and an off indicator. Two or more different descriptions may be associated with an updated status indicator. For example, the system may select among the two or more descriptions associated with the updated status indicator based on one or more of a task completion metric, a planned task start baseline date, and a planned task finish baseline date.

In an embodiment, the system associates at least one mobile device with the updated status indicator and provides a communication including the updated status indicator to the at least one mobile device.

In an embodiment, the status indicator is updated via determining that the planned task start baseline date is in a next reporting period, and the status indicator assigned to the task is the future indicator.

In an embodiment, the status indicator is updated via determining that the task completion metric is below a predetermined threshold and that the planned finish task baseline date is in the next reporting period. In such a case, the status indicator assigned to the task is the in jeopardy indicator, and the description includes an in jeopardy of finishing summary.

In an embodiment, the status indicator is updated by determining that the planned start task baseline date is in the next reporting period and that the current status entry for the task indicates that the task has not been started. In such a case, the status indicator assigned to the task is the in jeopardy indicator, and the description includes an in jeopardy of starting summary.

In an embodiment, the status indicator is updated by determining that the current status entry for the task, the planned start task baseline date and the planned finish task baseline date indicate that the task was started late but retains the planned finish task baseline date. In such a case, the status indicator assigned to the task is the in jeopardy indicator, and the description includes an in jeopardy—started late summary.

In an embodiment, the status indicator is updated by determining that the planned task start baseline date is equal to an actual start date for the task and that the planned task finish baseline date indicated is earlier than a planned task finish date indicated by the current status entry for the task. In such a case, the status indicator assigned to the task is the in jeopardy indicator, and the description includes an in jeopardy—finishing late summary.

In an embodiment, the status indicator is updated by determining that the planned task start baseline date and the current status entry for the task indicate that the task was started late and will be completed late. In such a case, the status indicator assigned to the task is the off indicator, and the description includes an off—started late/finishing late summary.

In an embodiment, the status indicator is updated by determining that the current status entry for the task indicates that the task has not been started, the planned baseline start date has been missed, but that the planned task finish baseline date indicated is retained. In such a case, the status indicator assigned to the task is the off indicator, and the description includes an off—missed start summary.

In an embodiment, the status indicator is updated by determining that the task was started on time but the planned baseline finish date has been missed. In such a case, the status indicator assigned to the task is the off indicator, and the description includes an off—missed finish summary.

In an embodiment, the status indicator is updated by determining that both the planned baseline start date and the planned baseline finish date have been missed, and the current status entry date indicates that the task has not yet started. In such a case, the status indicator assigned to the task is the off indicator, and the description includes an off—missed start and finish summary.

Additional embodiments are described and claimed, including methods, as well as devices/apparatuses, systems including multiple devices, and products.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of computer circuitry suitable for implementing a project management system as described herein.

FIG. 2 illustrates an example in tabular form of various task statuses, indicators thereof, and logic for determining the same.

FIG. 3 illustrates an example method for project and task status indicator updates using baseline metrics.

FIG. 4 illustrates example visual displays regarding task status indicators.

FIG. 5 illustrates an example distributed system facilitating communication and coordination of task status indicators and related data.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

There is currently no way to assign particular indicators coded to statuses derived from comparisons with baseline metrics. By way of non-limiting example, currently project management systems do not provide a capability to set base line dates (e.g., a planned task start baseline date and a planned task finish baseline date) that form the basis for status indicator updates.

Accordingly, an embodiment provides a functionality in which a project management system may be used to set baseline dates for project start and finish. With this baseline data, various status entries regarding a task for a project, e.g., task started entry, task completed entry, task percent (%) completed entry and the like, may be compared to the base line data and, given the particular logic coded for the comparison, update or assign a status indicator for the task.

An embodiment allows a project manager to access/review status indicators for tasks that have been assigned automatically according to relevant comparisons to baseline settings. By way of example, an embodiment may be used to enter a task status entry, e.g., task started. The project management system, according to an example embodiment, may automatically access stored project data in a database to extract a task completion metric, a planned task start baseline date, and a planned task finish baseline date. Given the current status entry for the task and the stored data, an embodiment may update a status indicator assigned to the task using the current status entry for the task along with the task completion metric, if any, the planned start task baseline date, and the planned finish task baseline date.

In this non-limiting example, the status update may reveal that the project has started late but should be on time, e.g., the planned task finish baseline date will be retained even though the current task status entry indicates a late start. In such a case, an embodiment may provide an indicator, e.g., a visual flag, notifying a review, e.g., a project manager, that the project has started late but that the project finish date originally planned is intact or is to be retained.

As will be understood from this description, the status indicators automatically assigned may be associated or mapped to different categories, e.g., depending on the severity of the situation. For example, a task that is on time and current may be given a first indicator, e.g., green color code, whereas a task that is behind (e.g., planned baseline finish date is past and the task has not been started) may be given a second indicator, e.g., a red color code. Intermediate indicators may also be provided, e.g., a warning flag showing one or more baseline dates have not been adhered to, indicating that the task baseline planned progress in jeopardy of not being adhered to, etc. The indicators may take a variety of forms, e.g., visual indicators provided in a project review screen, or some combination of indictors may be used.

Therefore, embodiments provide logic that supports refined tracking and updating the status of project tasks. This facilitates project management in that the reviewer may rely on the system to track and update the status of the tasks automatically. This same functionality provides the reviewing user with a quick and accurate view of task statuses such that any required actions may be more efficiently identified and implemented.

The present invention provides significant technical improvements to project management technology. The present invention is directed to substantially more than merely a computer implementation of a routine or conventional activity previously known in the industry as it significantly advances the technical efficiency, access and/or accuracy of project management systems, including defining new task statuses and generating additional task status data refined to reflect a task's current status as it specifically relates to initial planning data or metrics, as defined herein. The present invention is a specific advancement in the area of project management technology as it provides technical benefits in data accuracy, data availability and data integrity and such advances are not merely a longstanding commercial practice. The present invention provides improvement beyond a mere generic computer implementation as it involves the processing and conversion of significant amounts of data in a new beneficial manner as well as the interaction of a variety of specialized insurance, client and/or vendor systems, networks and subsystems. For example, in the present invention tasks of a project may be tracked relative to initial starting and ending metrics. This permits, among other technical benefits, an appropriate amount and type of data to be generated regarding a current task status, adherence to originally projected starting and completion dates, as well as the provisioning of advanced graphics and communications not heretofore available within project management systems. In turn, this advances the ability of an insurance carrier to make technical decisions regarding a project's status, its progress, and appropriate handling thereof based on the additional task level status indicators, updating techniques, and visual displays made possible by the various embodiments.

The illustrated example embodiments will be best understood by reference to the figures. The following description is intended only by way of example, and simply illustrates certain example embodiments.

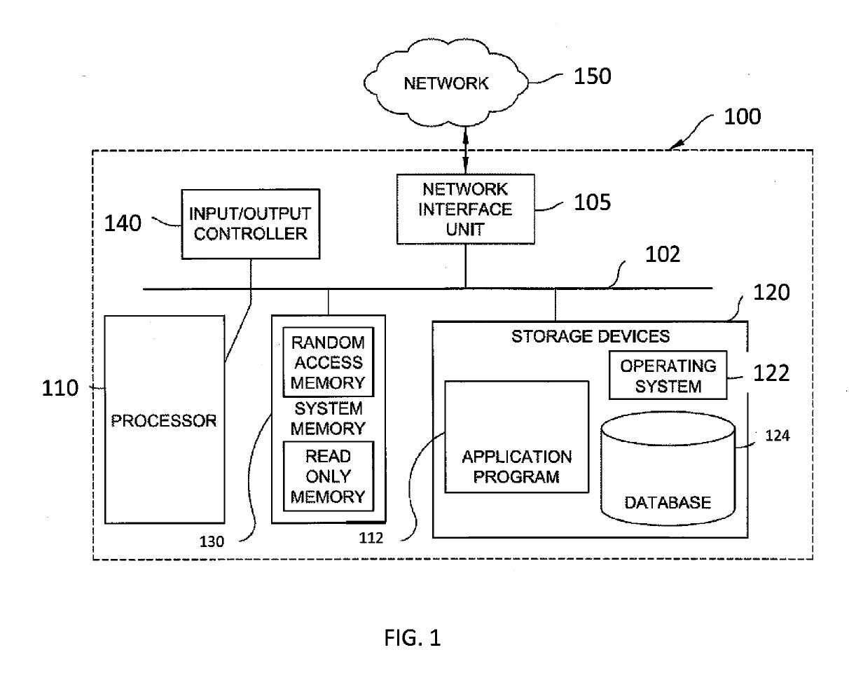

While various other circuits, circuitry or components may be utilized in computing devices, an example illustrated in FIG. 1 includes a system design found for example in laptop, desktop or other computing platforms. Such circuitry 100 may be used in a device that implements a project management system, as described herein, such as a computing device of an insurance carrier used for project management.

In the example of FIG. 1, a storage device 120 includes software such as a project management application program 112 that may be run or executed by processor(s) 110 according to an operating system 122. The circuitry 100 provides that the processor loads the operating system 122 and thereafter the application program 110, e.g., into memory 130.

System 100 typically includes a network interface 105 facilitating communications with other devices, e.g., a connection to other devices over a network 150 using components such as a WWAN transceiver, a WLAN transceiver or a wired connection, e.g., a LAN connection. Commonly, system 100 will include an input/output controller 140 for data input and display. System 100 typically includes various memory 130 and storage devices 120, for example a database 124, e.g., for storing insurance company project data referred to herein.

Device circuitry, as for example outlined in FIG. 1, may be by insurance carriers to execute project management software. It will also be apparent that other circuitry than the non-limiting example outlined in FIG. 1 may be used.

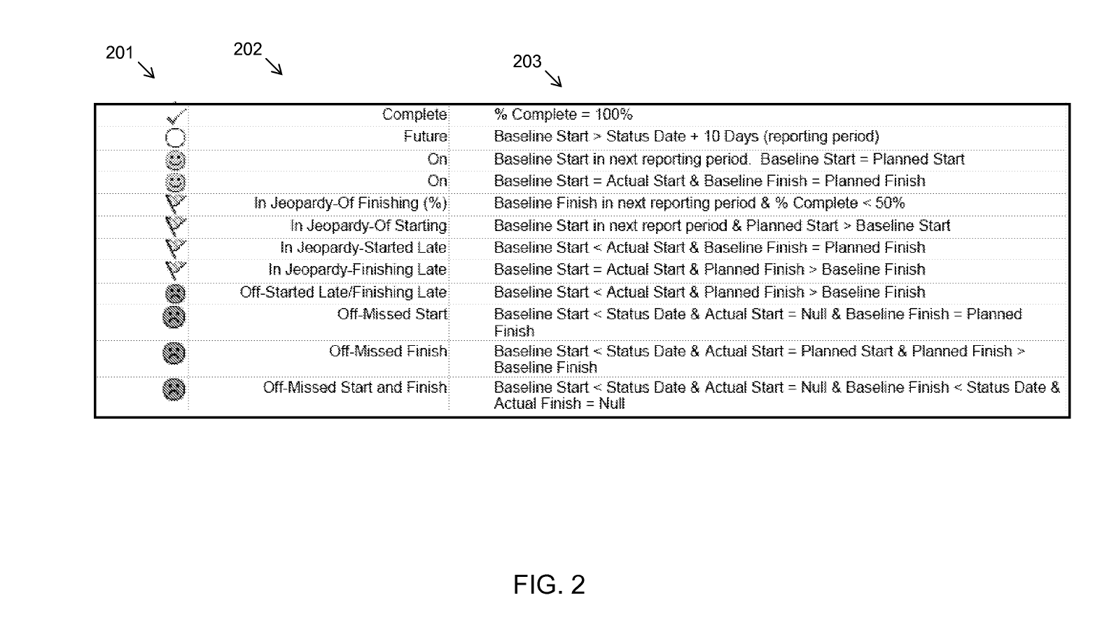

FIG. 2 illustrates an example of various task statuses and logic for determining the same. The status indicators 201 provide a graphic element for summarizing the status 202 of a particular task. The status 202 and associated indicator 201 are formed on the basis of logic 203 keyed to baseline metrics, e.g., planned baseline start dates and planned baseline finish dates.

As indicated, a variety of task statuses 202 may have the same indicator 201. By way of example, as illustrated in FIG. 2, a warning flag indicator 201 may be used as an intermediary indicator noting that at least some performance metric as related to a baseline expectation has not been met or is in jeopardy of not being met. This is in contrast to a completed status 202 and associated indicator 201, here illustrated as an open circle, or an “on” status 202 and associated indicator 201, here illustrated as a green circle. Each of these “on” and “completed” statuses indicates that a project task is either already successfully completed or is on target to reach completion. Otherwise, if a task status is indicative of the task being more materially off target than an intermediary or warning status, another indicator may be used, e.g., an “off” type status 202 and related indicator 201, here illustrated as a red circle.

Also illustrated in FIG. 2 is example logic for automatically determining the task status based on the baselines, the current entry data, and/or the completion data, e.g., as stored in a database 124. By way of example, a system 100 for updating status indicators for an insurance company project using a baseline metric may access a database 124 storing data related to an insurance project. The database 124 may for example include start and finish task dates for a particular task for a particular project. If a task has already been completed or partially completed, data relating to the completion of the task may also be stored in the database 124.

The system 100 includes an input/output element 124 that accepts a current status entry, e.g., via input via a touch screen or keyboard, for a task of the insurance project. A processor 110 uses a project insurance application program 112, e.g., stored in memory 130, to access the data stored in the database 124 to extract a task completion metric, if any, a planned task start baseline date, and a planned task finish baseline date for the task related to the current status entry for the task.

Having this information, the system 100, according to logic provided by the application program 112, may update, based on the current status entry for the task, a status indicator assigned to the task using the task completion metric, the current status entry for the task, and the planned start task baseline date and the planned finish task baseline date. By way of example, the system 100 may update the status indicator assigned to the task as one of a “complete” indicator, a “future” indicator, an “on” indicator, an “in jeopardy of finishing” indicator, an “in jeopardy of starting” indicator, an “in jeopardy—started late” indicator, an “in jeopardy of finishing late” indicator, an “off—started late/finishing late” indicator, an “off—missed start” indicator, “an off—missed finish” indicator, and an “off—missed start and finish indicator”. The logic for determining each indicator will be described herein.

In a case where the system 100 determining that the task completion metric indicates that the task has been completed, the system may update the status indicator assigned to the task to the complete indicator. This may correspond to the case where the current status entry for the task is that of completion of the task. Likewise, if the current status entry for the task is that of partial completion, the system may store this information in the database 124 for later use, as further described herein.

In a case where the system 100 determines that, at the time of the current status entry, the planned task start baseline date is in a next reporting period, the system may update (or retain) the status indicator assigned to the task as the future indicator, i.e., denoting that the task is to begin sometime in the future. Likewise, when system 100 determines that the current status entry for the task, the planned start task baseline date and the planned finish task baseline date indicate that the task is on schedule, the status indicator assigned to the task is the “on” indicator.

If, at the time of the current status entry, the system 100 determines that the task completion metric, e.g., stored in database 124, is below a predetermined threshold (e.g., 50%) and that the planned finish task baseline date is in the next reporting period, and thus the task is to be completed in the near future (however defined by the logic of the program according to the reporting period length), the status indicator assigned to the task is the in jeopardy of finishing indicator.

When the system 100 determines that the planned start task baseline date is in the next reporting period and that the current status entry for the task indicates that the task has not been started, where the task was scheduled to be started (according to the baseline start date), the system 100 sets the status indicator assigned to the task to the in jeopardy—of starting indicator. Likewise, if the system 100 determines that the current status entry for the task, e.g., a task starting entry, the planned start task baseline date, e.g., a start date in the past, and the planned finish task baseline date indicate that the task as started late but retains the planned finish task baseline date, the system 100 sets the status indicator assigned to the task to the in jeopardy—started late indicator.

As another example of a jeopardy warning status, if the system 100 determines that the planned task start baseline date is equal to an actual start date for the task, and that the planned task finish baseline date indicated is earlier than a planned task finish date indicated by the current status entry for the task, the status indicator assigned to the task by the system 100 will be the in jeopardy—finishing late indicator.

Where the system 100 determines that not only does the current status entry and the data stored in the database 124 indicate that the task is somewhat off schedule or likely to be, the system may set the status indicator to a different, off track type indicator. For example, where the system determines that the planned task start baseline date and the current status entry for the task indicate that the task was started late and will be completed late, the status indicator assigned to the task is the off—started late/finishing late indicator. For example, the current status entry for the task may indicate that the task has begun later or is progressing more slowly than anticipated, e.g., as determined by reference to a percent completion baseline (although this is not strictly necessary). This in turn may allow the system 100 to determine, by comparison with the relevant baseline(s) and the current status entry, that the task is going to be completed late.

In contrast, the system 100 may determine that the current status entry for the task indicates that the task has not been started, the planned baseline start date has been missed, but that the planned task finish baseline date indicated is to be retained. In such a case, the system 100 may assign a status indicator to the task of off—missed start indicator. This for example may correspond to a situation where a task was started late, but not materially so, or a task has been started late but is mostly completed, i.e., not jeopardizing the baseline finish date. In contrast, the system 100 may determine, e.g., using a task percent completion status entry received after the baseline finish date, that the task was started on time but the planned baseline finish date has been missed. In such a case, the system 100 may set the indicator assigned to the task as off—missed finish.

In another example, the system 100 may determine that both the planned baseline start date and the planned baseline finish date have been missed, and the current status entry date indicates that the task has not yet started. In such a case, the system 100 may set the status indicator assigned to the task to the off—missed start and finish indicator. This corresponds to an off target case where the task has yet to be started, although the baseline metrics (both start and end dates) indicate that the task should have been started and in fact completed.

By way of example, system 100 logic that may be included in an application program 112 may take the following form written in visual basic script language:

llf([% Complete=100,“Complete”,llf([Actual Start]=4294967295 And [Baseline
Estimated Start<=[Status Date] And [Actual Finish]=4294967295 And [Baseline
Estimated Finish<=[Status Date], “Off-Missed Start and Finish”,llf([Actual
Start]=4294967295 And [Baseline Estimated Start]<=[Status Date] And [Baseline
Estimated Finish]>[Status Date] And [Baseline Estimated Finish]>=[Scheduled
Finish],“Off-Missed Start”,llf([Actual Finish]=4294967295 And [Baseline Estimated
Finish]<=[Status Date], “Off-Missed Finish”,llff([Actual Start]>[Baseline Estimated Start]
And [Baseline Estimated Start]<=[Status Date] And [Baseline Estimated
Finish]<[Scheduled Finish],“Off-Started Late/Finishing Late”,llf([Baseline Estimated
Finish]<=[Status Date] And [Scheduled Finish]>[Baseline Estimated Finish], “Off-Finishing
Late”,llf([Baseline Estimated Start]<=[Status Date] And [Baseline Estimated
Finish]<=[Status Date]+14 And [% Complete]<50 And [Actual Start]<>4294967295,“In
Jeopardy-Of Finishing (%)”,llff([Actual Start]>[Baseline Estimated Start] And [Actual
Start]<>4294967295 And [Baseline Estimated Start]<=[Status Date] And [Baseline
Estimated Finish]=[Scheduled Finish],“In Jeopardy-Started Late”,llff([Actual
Start]=[Baseline Estimated Start] And [Baseline Estimated Finish]>[Status Date] And
[Baseline Estimated Finish]<[Scheduled Finish],“In Jeopardy-Finishing Late”,llf([Baseline
Estimated Start]>[Status Date]+14 And [Actual Start]=4294967295, “Future”,llff([Actual
Start]=4294967295 And [Baseline Estimated Start]>[Status Date] And [Baseline
Estimated Start]<[Scheduled Start],“In Jeopardy-Of Starting”,“On”)))))))))))

For example, Microsoft PROJECT software may accept this input into a custom field as an input formula.

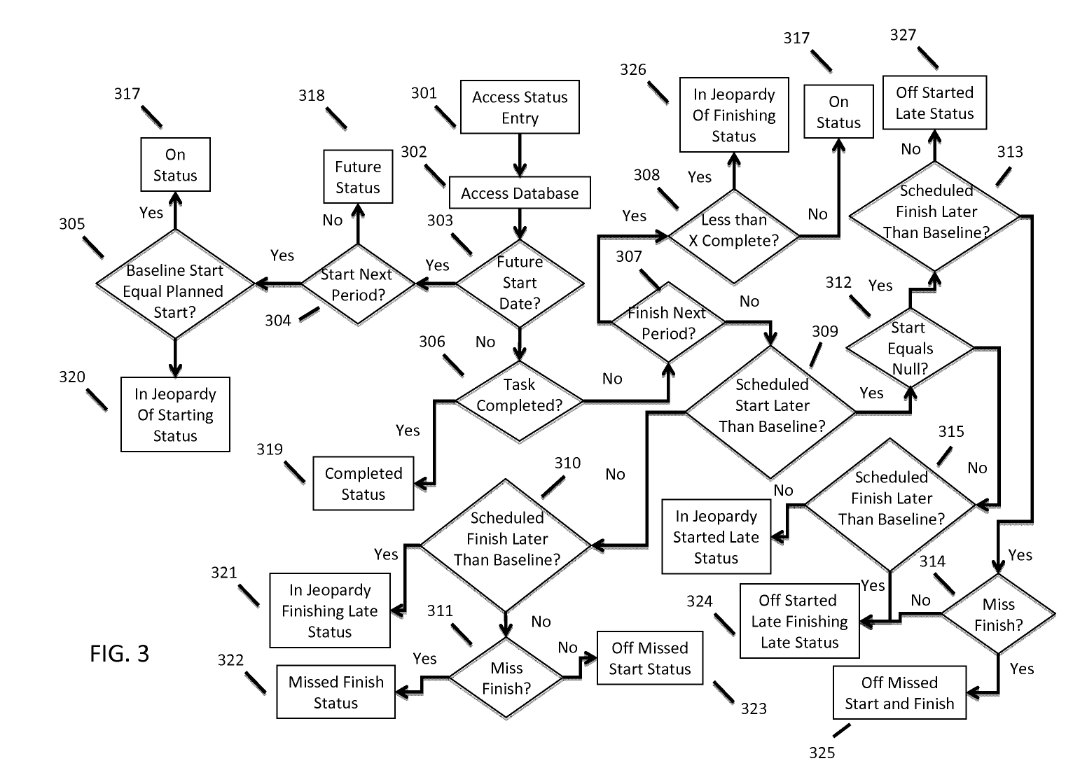

This example logic is illustrated in a flow chart in FIG. 3. In the example, an embodiment accesses the status entry at 301, which includes date information or other timing information, and accesses the database at 302 to determine if there is a future start date at 303 for the task in question. If so, the system next determines if there is a start date in the next reporting period at 304, e.g., within the next 10 days. If yes, then the system assigns the future status indicator 318 to the task. However, if no start date is within the next reporting period, as determined at 304, the system checks to determine if the baseline start equals the planned start at 305. If so, the task has not yet started nor is it scheduled to start, thus an on indicator 317 is set. If not, the in jeopardy of starting status 320 is set, indicating that the task may be started late.

If no future start date is determined at 304, it is determined at 306 if the task is completed at 307. If so, the completed status 319 is set. However, if not completed, the system determines if there is a planned finish date in the next reporting period at 307. If so, i.e., the task should be completed soon, the system checks the percent complete value for the task and if not above a predetermined threshold, as determined at 308, the in jeopardy of finishing status 326 is set. If the task is over the threshold complete value, the on status 317 is set, as the task is on track.

If the task is not set to complete within the next reporting period, the system determines if the scheduled start time is later than the baseline at 309. If not, the system checks at 310 to determine if the scheduled finish time is later than the baseline finish time. If so, the system sets the in jeopardy of finishing late status 321. Otherwise, the system checks to determine if the finish has been missed at 311. If so, the system sets the missed finish status 322 indicator. Otherwise, the system sets the off missed start status indicator 323.

If the scheduled start time is later than the scheduled baseline start, the system, as determined at 309, determines if the task has been started (start equals null if not started) at 312. If the task has not been started, the system determines at 313 if the scheduled finish time is later than the baseline finish time at 314. If not, the system sets the off started late status 327 indicator. Otherwise, the system determines at 314 if the finish has been missed, and if so sets the off missed start, missed finish status 325, as the task has not started and the finish has been missed.

If the task is started late but has started, i.e., the starting value is not null as determined at 312, the system determines if the scheduled finish is later than the baseline finish at 315. If so, the system sets the off started late finishing late status 324. Otherwise, the system sets the in jeopardy started late status, as the task, although started late, is simply in jeopardy but may be completed on time, as currently scheduled.

The task statuses set by the system and related indicators may thus be updated using baseline metrics. This provides a user, e.g., project managers and others, with the ability to more accurately determine the status of tasks and track the progress of tasks that make up a project. In addition, combinations of data may be included, offering refined task status information along with the task indicators, e.g., such that a task indicator (“on”, “in jeopardy”, “off” or the like) is associated with additional information such as a textual summary and/or visual display may be provided, offering more refined information regarding the task status.

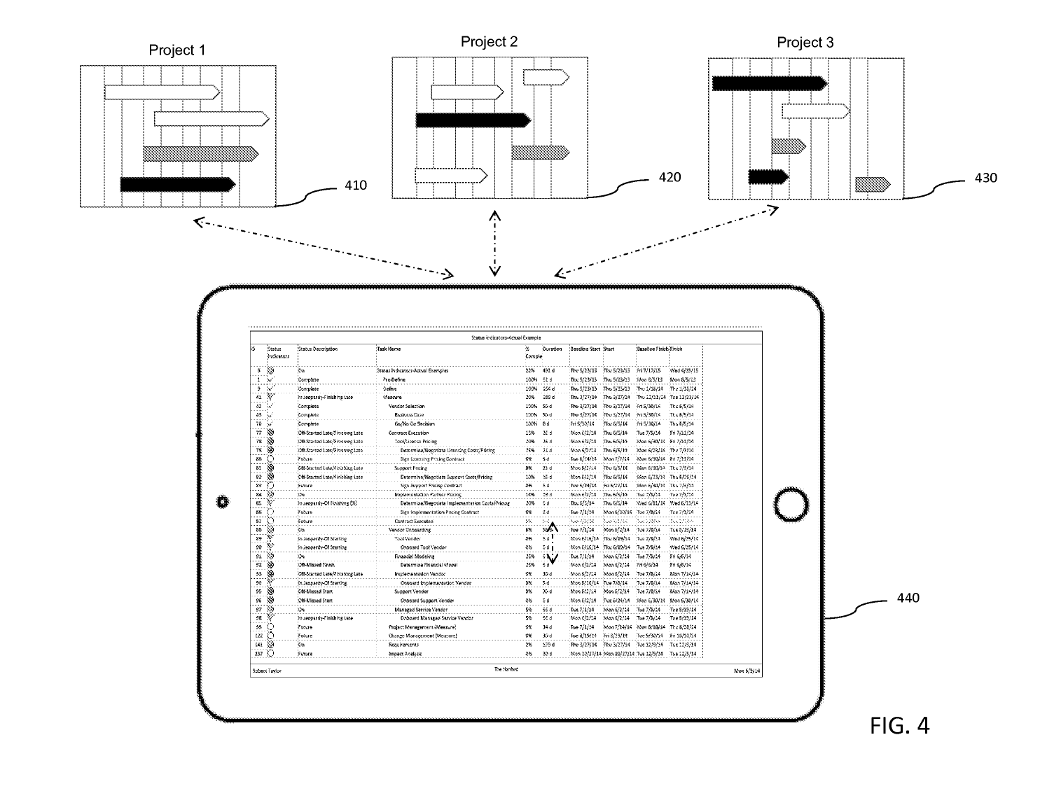

For example, as illustrated in FIG. 4, visual displays associated with the task status indicators and/or textual descriptions summarizing a task status indicator detail may be provided using the baseline metrics. In the non-limiting example of FIG. 4, projects (1-3) may be visually summarized in graphic displays 410, 420 and 430. The insurance company project, for example, may include various tasks (illustrated as shaded block arrows in visual displays 410, 420, and 430) that have different planned start and finish dates (as indicated by different positioning of the block arrows relative to the x axis of the visual display). The tasks may also be in various states (of completion, of starting, of being on time or late, etc., as indicated by different shading of the block arrows).

Underlying data to of projects 1-3 may be stored for example in a database, e.g., database 124. This data may be provided to a device, e.g., a mobile device such as tablet 440, or the data may be stored thereon and used for generating displays for local display on the tablet device 440 and/or other devices, as further described herein. By way of example, the tablet device 440 may include raw task status data, e.g., for example as illustrated in tabular form in FIG. 2, including status entry data 203, textual summaries 202, and status indicators 201. This raw task status data may be used by a manager or other user to retrieve a report on the current statuses of tasks for a project, as summarized for example in FIG. 2 and/or to generate visual summaries, e.g., graphic displays 410, 420, and 430.

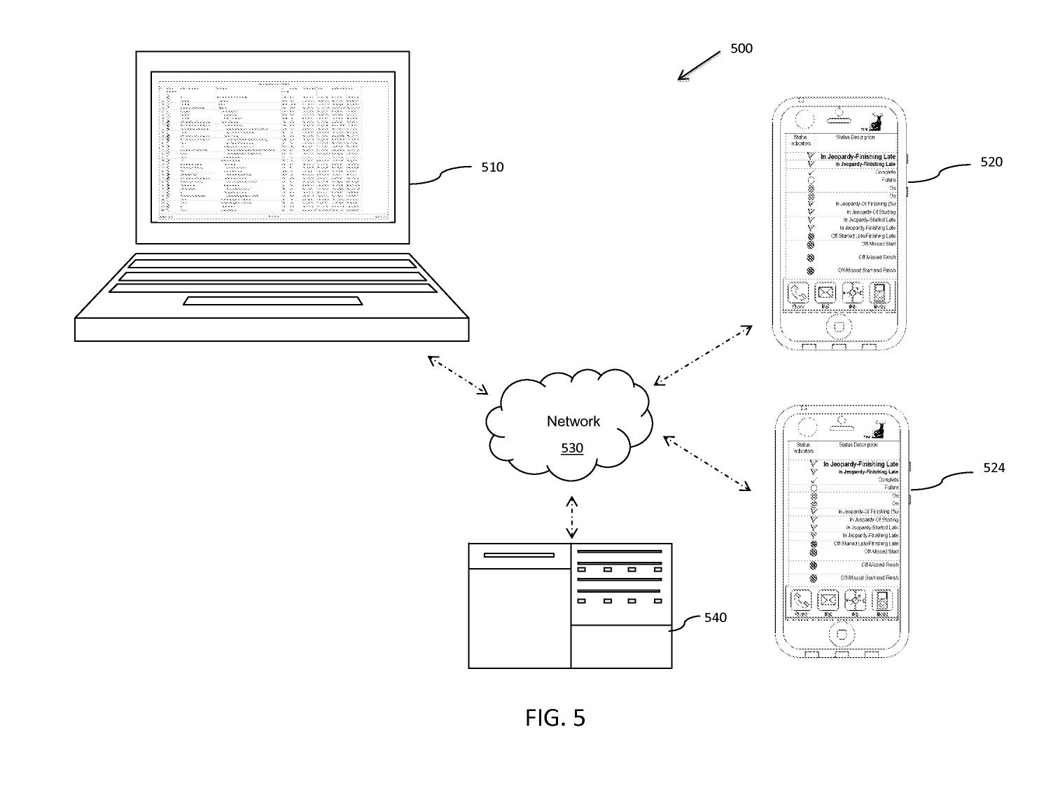

As illustrated in the non-limiting example of FIG. 5, in an embodiment, a distributed system 500 is provided such that the task status information may be entered into the system 500 by various devices, e.g., user mobile devices 510, 520, and 524, and stored in a central device 540. In addition to entering data into the system (e.g., a current status entry for a task), reporting may be made to various devices (e.g., updated task statuses, graphic displays, textual summaries, etc., either pushed to the devices and/or retrieved by various devices), e.g., user mobile devices 510, 520, and 524.

Such data input into the distributed system 500, e.g., communication of data between user device 520 (via network 530) to central device 540, may be automated or semi-automated. By way of example, if a user enters data into device 520 that indicates a task has started, completed, progressed by x percent, etc., such entry may cause an application running on user device 520 to issue a communicating to device 540 updating the status of the task. Likewise, device 540 may poll devices 510, 520, and 524 for updates.

Similarly, device 540 (or similar device acting as a coordinating or managing device) may process task updates and distributed them to other devices, again in an automated or semi-automated fashion. By way of example, an updated task status determined by device 540 may be communicated to all devices in the distributed system 500 or a sub-set thereof. As a particular, non-limiting example, device 540 may update a task, e.g., task has started late, and identify one or more user devices associated with the updated task status.

These devices that are associated with the updated task status may be identified/determined in a variety of ways. For example, the device inputting the data allowing the task status update to be generated may be identified for communication of the updated status. Additionally, a managing user's device, e.g., having oversight of the project and/or task, may be identified and provided with the updated task status. Likewise, other users working on the task and/or project (e.g., dependent task on that being updated) may be identified and an updated task status may be communicated to their devices, e.g., devices 510, 520, and/or 524.

It should be noted that in addition to the updated task status, additional or alternative information may be provided. For example, data may be communicated by device 540 to devices 520, 524, and/or 510 such that a graphic display, e.g., 410, may be rendered on the mobile devices. Likewise, underlying textual summaries further describing the updated task status may be provided. By way of example, if the task status is in jeopardy, additional textual summary data may be provided to the mobile devices indicating why the in jeopardy status has been used (e.g., in jeopardy of starting late, in jeopardy of finishing late, etc.).

As may be appreciated from the foregoing, the various embodiments may implement automatic updating of task status indicators according to various logic schemes put in place. This assists the user in that the status of tasks may be automatically updated, facilitating quick review of task status.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable storage medium(s) may be utilized. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage medium is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A system for updating status indicators for an insurance company project using a baseline metric, comprising:
a database storing data related to an insurance project;
an input element that accepts a current status entry for a task of the insurance project;
a processor; and
a memory, with the memory storing instructions executable by the processor to:
access the data stored in the database to extract a task completion metric, a planned task start baseline date, and a planned task finish baseline date;
access the current status entry for the task;
update, based on the current status entry for the task, a status indicator assigned to the task using the task completion metric, the current status entry for the task, the planned start task baseline date and the planned finish task baseline date;
wherein the updated status indicator assigned to the task is selected from the group of an on indicator, an in jeopardy indicator, and an off indicator; and
generate, in a visual display, a description summarizing the updated status indicator.

2. The system of claim 1, wherein the description is one or more of a visual graphic and a textual summary.

3. The system of claim 1, wherein two or more different descriptions are associated with an updated status indicator.

4. The system of claim 3, wherein the instructions are further executable by the processor to select among the two or more descriptions associated with the updated status indicator based on one or more of a task completion metric, a planned task start baseline date, and a planned task finish baseline date.

5. The system of claim 1, wherein the instructions are further executable by the processor to:
associate at least one mobile device with the updated status indicator; and
provide a communication including the updated status indicator to the at least one mobile device.

6. The system of claim 2, wherein:
to update the status indicator comprises determining that the planned task start baseline date is in a next reporting period; and
the status indicator assigned to the task is the future indicator.

7. The system of claim 1, wherein:
to update the status indicator comprises determining that the task completion metric is below a predetermined threshold and that the planned finish task baseline date is in the next reporting period;
the status indicator assigned to the task is the in jeopardy indicator; and
the description includes an in jeopardy of finishing summary.

8. The system of claim 1, wherein:
to update the status indicator comprises determining that the planned start task baseline date is in the next reporting period and that the current status entry for the task indicates that the task has not been started;
the status indicator assigned to the task is the in jeopardy indicator; and
the description includes an in jeopardy of starting summary.

9. The system of claim 1, wherein:
to update the status indicator comprises determining that the current status entry for the task, the planned start task baseline date and the planned finish task baseline date indicate that the task was started late but retains the planned finish task baseline date;
the status indicator assigned to the task is the in jeopardy indicator; and
the description includes an in jeopardy—started late summary.

10. The system of claim 1, wherein:
to update the status indicator comprises determining that the planned task start baseline date is equal to an actual start date for the task and that the planned task finish baseline date indicated is earlier than a planned task finish date indicated by the current status entry for the task;
the status indicator assigned to the task is the in jeopardy indicator; and
the description includes an in jeopardy—finishing late summary.

11. The system of claim 1, wherein:
to update the status indicator comprises determining that the planned task start baseline date and the current status entry for the task indicate that the task was started late and will be completed late;
the status indicator assigned to the task is the off indicator; and
the description includes an off—started late/finishing late summary.

12. The system of claim 1, wherein:
to update the status indicator comprises determining that the current status entry for the task indicates that the task has not been started, the planned baseline start date has been missed, but that the planned task finish baseline date indicated is retained;
the status indicator assigned to the task is the off indicator; and
the description includes an off—missed start summary.

13. The system of claim 1, wherein:
to update the status indicator comprises determining that the task was started on time but the planned baseline finish date has been missed;
the status indicator assigned to the task is the off indicator; and
the description includes an off—missed finish summary.

14. The system of claim 1, wherein:
to update the status indicator comprises determining that both the planned baseline start date and the planned baseline finish date have been missed, and the current status entry date indicates that the task has not yet started;
the status indicator assigned to the task is the off indicator; and
the description includes an off—missed start and finish summary.

15. A method for updating status indicators for an insurance company project using a baseline metric, comprising:
accessing, using a processor, a database storing data related to an insurance project;
accepting, via an input element of a computer, a current status entry for a task of the insurance project;
extracting, using a processor, data stored in the database associated with the insurance project, the data extracted including a task completion metric, a planned task start baseline date, and a planned task finish baseline date;
comparing, using a processor, the current status entry for the task with the task completion metric, the planned task start baseline date, and the planned task finish baseline date;
updating, based on the current status entry for the task, a status indicator assigned to the task using the task completion metric, the current status entry for the task, the planned start task baseline date and the planned finish task baseline date;
wherein the updated status indicator assigned to the task is selected from the group of an on indicator, an in jeopardy indicator, and an off indicator; and
generating, in a visual display, a description summarizing the updated status indicator.

16. The method of claim 15, wherein the description is one or more of a visual graphic and a textual summary.

17. The method of claim 16, wherein two or more different descriptions are associated with an updated status indicator.

18. The method of claim 17, further comprising selecting among the two or more descriptions associated with the updated status indicator based on one or more of a task completion metric, a planned task start baseline date, and a planned task finish baseline date.

19. The method of claim 15, further comprising:
associating at least one mobile device with the updated status indicator; and
providing a communication including the updated status indicator to the at least one mobile device.

20. A system for updating status indicators for an insurance company project using a baseline metric, comprising:
a database storing data related to an insurance project;
an input element that accepts a current status entry for a task of the insurance project;
a processor; and
a memory, with the memory storing instructions executable by the processor to:
access the data stored in the database to extract a task completion metric, a planned task start baseline date, and a planned task finish baseline date;
access the current status entry for the task; and
update, based on the current status entry for the task, a status indicator assigned to the task using the task completion metric, the current status entry for the task, the planned start task baseline date and the planned finish task baseline date.
